(19) United States
(12) Patent Application Publication
(10) Pub. No.: US 2026/0027577 A1
(43) Pub. Date: Jan. 29, 2026

(54) Universal Masking Tool

(71) Applicant: James Snyder, Las Vegas, NV (US)

(72) Inventor: James Snyder, Las Vegas, NV (US)

(21) Appl. No.: 18/787,551

(22) Filed: Jul. 29, 2024

(51) Int. Cl. B05B 12/24; B65H 35/00

(52) U.S. Cl. CPC B05B 12/24; B65H 35/0033; B65H 35/0073; B65H 2301/5154; B65H 2701/377

(57) ABSTRACT

A combination right and left-handed masking tool for painters, drywallers and other construction workers is disclosed. The invention provides housing masking tape dispensers located on both the left and right sides of a masking tool both connected to a flat support member. The combination right and left-handed masking tool operates in the same fashion as existing right-handed masking tool using a tape dispenser on the right side but includes the added feature of supporting a left-handed tape dispenser. An adjustable handle is attached to the flat support member connected between the right and left-handed tape dispensers and may be repositioned towards the either end of the flat support member or at its center for better balance and ergonomics during use.

### BACKGROUND OF THE INVENTION

### Field of the Invention

This invention relates to a universal handheld masking tool for dispensing and applying masking to a surface generally in preparation for painting. More specifically, to a modified prior art masking tool which provides a masking tape dispenser located on both the left and right sides of the masking tool along with a centralized handle.

### Prior Art

A handheld painter's masking tool is a device that is used to quickly and efficiently apply masking tape to surfaces before painting. It typically consists of a handle with a built-in dispenser for the masking tape. The tool allows the user to easily pull out and tear off the desired length of tape, and then apply it smoothly and evenly onto the surface to be painted. This tool is especially useful for painters working on large projects or tight spaces where precision masking is required. It helps to save time and effort compared to manually applying tape by hand, and ensures a professional-looking result.

However, handheld masking tools are typically small and cover only a narrow area. Additionally, using a handheld masking tool effectively requires a steady hand and some level of skill. Inexperienced users may find it difficult to achieve clean, straight lines, especially around corners and edges. More specifically achieving consistent pressure and angle while applying the masking tape may be challenging. An inconsistent application may lead to paint bleeding under the tape or uneven lines.

Also, handheld masking tools are often less effective on uneven or textured surfaces. The tape may not adhere well, resulting in gaps where paint may seep through. These tools are generally designed for straight lines and may not work well for curves or intricate patterns. This limits their usefulness in more detailed painting projects. Incorrect use or mistakes may lead to wasted tape. If the tool applies the tape unevenly or is reapplied, this ends up using more tape than necessary. While handheld masking tools may save time, they represent an additional expense compared to traditional masking tape alone.

Prolonged use of a traditional right-hand masking tool may cause hand fatigue or discomfort, especially if the tool is not ergonomically designed. This may be an issue during large or extended projects. Instead of struggling to mask ceilings and the bottom of windows and cabinets using only a traditional right-hand masking tool, what is needed is a masking tape dispenser housing both left and right side tape dispensers along a centralized handle. This additional feature would readily accommodate all masking requirements for a drywaller or painter so vulnerable finished surfaces and objects are protected against splashes.

Therefore a universal masking tool that greatly improves masking capabilities by using both a left-hand and right-hand masking tool while providing convenience, time-savings and efficiency for painters and drywallers is provided. The present invention solves all these problems in a unique and novel way.

### SUMMARY OF THE INVENTION

A combination right and left-handed masking tool for painters, drywallers and other construction workers is disclosed. The invention provides housing masking tape dispensers located on both the left and right sides of a masking tool both connected to a flat support member. The combination right and left-handed masking tool operates in the same fashion as an existing right-handed masking tool using a tape dispenser on the right side but includes the added feature of supporting a left-handed tape dispenser. An adjustable handle is attached to the flat support member connected between the right and left-handed tape dispensers and may be repositioned towards the either end of the flat support member or at its center for better balance and ergonomics during use.

### BRIEF DESCRIPTION OF DRAWINGS

FIG. 1 is a pictorial view of a prior art right-handed masking tool; and

FIG. 2 is a graphical picture of the universal masking tool in accordance with the present invention.

### DETAILED DESCRIPTION OF THE INVENTION

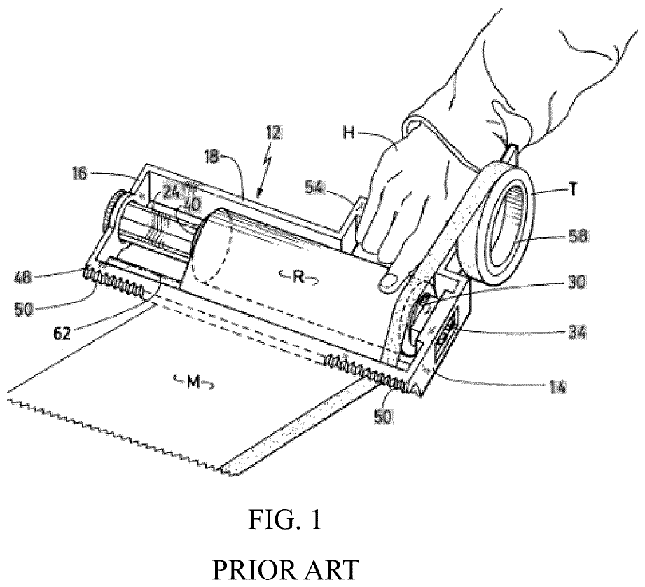

Referring now to FIG. 1, there is shown a combination right and left-handed masking tool for painters, drywallers and other construction workers. Unlike existing right-handed masking tools currently available on the market, the invention provides a masking tape dispenser located on both the left and right sides along with a centralized handle. Turning back to FIG. 1 there is shown a pictorial view of a prior art right-handed masking tool 10. The prior art right-handed masking tool 10 houses a tape roll holder 58 located at the left hand side of the tool, as viewed from a forward direction, paper roll R is engaged on paper roll holder 24 as the latter is urged through opening 26 towards the left hand side of frame 12, with stop collar 40 suitably located on holder 24 or omitted therefrom as the case may be, according to the width of paper roll R, so that when holder 24 is snapped into position roll R will be free to rotate on the holder, but will be retained in a fixed axial position.

The leading edge L of masking paper from roll R is threaded manually through slot 46 in a manner to exit forwardly therefrom, the forward offset of one of jaws 48 from the other facilitating the threading. The threading is further facilitated by rounding jaws 48 at 62 at the rearward entrance to slot 46. A roll of masking tape T is engaged on tape roll holder 58, it being noted that the masking tape T and paper roll R are both positioned in a manner to unwind in the same rotational sense from the top of the respective rolls. The axial offset of arm 56 will be such that masking tape from roll T overlaps the left hand margin of the masking paper from roll R to form a composite masking M for application to a surface.

When a sufficient length of masking M has been dispensed, it may be severed by either of jaws 48 by a upward or downward movement of jaws 48, as is convenient. During the severing operation and at other times it is often desirable to prevent masking paper roll R from turning, or to provide a frictional resistance to turning, and handles 54 is disposed on frame 12 whereby when the handle is grasped by the hand H of a user during normal operation, as seen in FIG. 1, one or more fingers of that hand may extend to about the geometric axis of roll R whereby a suitable braking resistance may be provided by the fingers.

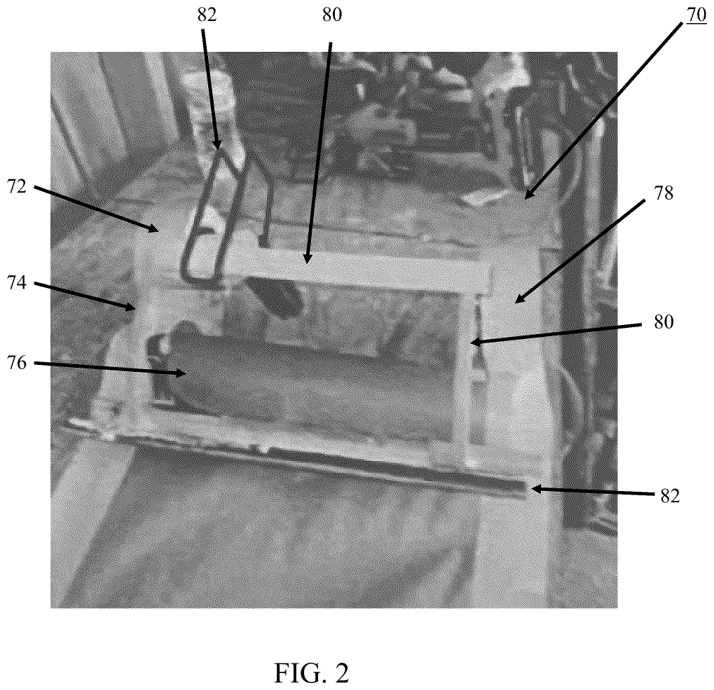

Referring now to FIG. 2, there is shown a combination right and left-handed masking tool 70 for painters, drywallers and other construction workers. The combination right and left-handed masking tool 70 houses tape dispensers 72 and 78, respectively, located on both the left-hand portion 78 and right-hand portion 72 of the masking tool 70 are both connected to a flat support member 80. The combination right and left-handed masking tool 70 operates in the same fashion as existing right handed masking tool using a tape dispenser on the right side but includes the added feature of supporting a left-handed tape dispenser. An adjustable handle 82 is attached to the flat support member connected between the right and left-handed tape dispensers and may be repositioned towards the either end of the flat support member 80 or at its center for better balance and ergonomics during use.

The right-hand portion 72 of this tool 70 which would work very well with walls and three sides of windows and cabinets. The left-hand portion 78 of this tool 70 would readily accommodate ceilings and the bottom of windows and cabinets where current right-hand masking tools traditionally operate very poorly. It should be understood that using a masking tool having both left and right masking dispensers would save considerable time when masking and less physical demand and stress on the user.

The universal masking tool could be used extensively by professional painters and drywall installers on all paint and drywall texture applications. It may also be used in various other possible situations where certain surfaces or objects need to be protected from stains, concrete, or other liquids or partially-liquid substances that might splash on finished products.

The universal masking tool 70 of the present invention would speed up important projects and reduce time thereby saving a business money. It would also enable the masking work to be performed in a less physically demanding manner to keep the user from becoming stressed and fatigued. The strong plastic hand tool 70 would also be durable, affordable, and very user-friendly.

The universal masking tool 70 of the present invention measures approximately 7 to 8 inches tall, 9 to 10 inches long and 14 inches wide. It would be made from plastic, wood or metal with some metal fasteners and a cutting blade. In summary, the modified and enhanced masking tool would utilize the existing right handed masking tool with the tape dispenser on the right side, only adding a flat support member across the top to another tape dispenser on the left side handle which may be repositioned towards the center for better balance and ergonomics.

While the invention has been described in detail and with reference to specific embodiment thereof, it will be apparent to one skilled in the art that various changes and modifications can be made therein without departing from the spirit and scope thereof.

What is claimed is:

1. A universal masking tool for painters, drywallers and other construction workers, comprising:
a masking tape dispenser body,
said masking tape dispenser body housing left and right-side masking tool tape dispensers,
said left and right-side masking tool tape dispensers both connected to a flat support member, wherein an adjustable handle is attached to a center of said flat support member connected between the right and left-handed tape dispensers.

2. The universal masking tool according to claim 1 wherein said adjustable handle may be repositioned towards either end of said flat support member.

3. The universal masking tool according to claim 1 wherein said adjustable handle may be repositioned at a center of said flat support member for better balance and ergonomics during use.

4. The universal masking tool according to claim 1 wherein said combination right and left-handed masking tool operates in the same fashion as existing right-handed masking tool using a tape dispenser on the right side but includes the added feature of supporting a left-handed tape dispenser.

5. The universal masking tool according to claim 1 wherein said combination right and left-handed masking tool is fabricated using an ultra-using wood.

6. The universal masking tool according to claim 1 wherein said combination right and left-handed masking tool is fabricated using an plastic.

7. The universal masking tool according to claim 1 wherein said combination right and left-handed masking tool is fabricated using an ultra-using metal.

8. The universal masking tool according to claim 1 wherein said combination right and left-handed masking tool measures approximately 7 to 8 inches tall.

9. The universal masking tool according to claim 1 wherein said combination right and left-handed masking tool measures approximately 9 to 10 inches long.

10. The universal masking tool according to claim 1 wherein said combination right and left-handed masking tool measures 14 inches wide.

11. The universal masking tool according to claim 1 wherein said combination right and left-handed masking tool is fabricated using metal fasteners and a cutting blade.
